(19) United States
(12) Patent Application Publication
(10) Pub. No.: US 2014/0311657 A1
(43) Pub. Date: Oct. 23, 2014

(54) VACUUM ROLL SYSTEM FOR FORMING AND APPLYING HANDLE ON SUBSTRATE

(71) Applicant: H.B. FULLER COMPANY, ST. PAUL, MN (US)

(72) Inventor: JORGE A. NASH, Vancouver, WA (US)

(73) Assignee: H.B. FULLER COMPANY, ST. PAUL, MN (US)

(21) Appl. No.: 13/867,709

(22) Filed: Apr. 22, 2013

(51) Int. Cl. B32B 38/00

(52) U.S. Cl. CPC B32B 38/0012
USPC 156/196; 156/458; 156/378

(57) ABSTRACT

A system comprising:
a vacuum roll configured to receive a material, wherein the vacuum roll defines a peripheral surface having a contoured portion; and
an element forming a nip with the vacuum roll so that the material can be applied to a substrate advancing through the nip.

### SUMMARY

Disclosed herein are vacuum roll systems and methods for forming and applying a contoured material onto a substrate.

In one embodiment there is disclosed herein a system comprising:

a vacuum roll configured to receive a material, wherein the vacuum roll defines a peripheral surface having a contoured portion; and

an element forming a nip with the vacuum roll so that the material from the vacuum roll can be applied to a substrate advancing through the nip.

Also disclosed herein is a vacuum roll comprising:

a hub that defines a peripheral surface having a contoured portion, and comprises a first wall, a second wail, axially extending first holes formed in the first wall, and second holes formed in the peripheral surface, wherein the first holes communicate with the second holes; and

a manifold coupled to the first wall of the hub, the manifold comprising an arcuate slot configured to serially communicate with the first holes of the hub.

Further disclosed herein is a method for applying a contoured material to a substrate, comprising:

advancing a material from a feed section to a vacuum roll, wherein the vacuum roll defines a peripheral surface having a contoured portion;

advancing the material along the peripheral surface of the vacuum roll so as to form a contour in the material;

advancing the contoured material along the peripheral surface of the vacuum roll to a nip between the vacuum roll and a back roll; and

applying the contoured material to a substrate advancing through the nip.

The foregoing will become more apparent from the following detailed description, which proceeds with reference to the accompanying figures.

### BRIEF DESCRIPTION OF THE DRAWINGS

The system and methods disclosed herein will be described with reference to the accompanying drawings wherein:

FIG. 1A is a perspective view of a first embodiment of a contour vacuum applicator as viewed from the upper right side;

FIG. 1B-1F is a diagrammatic fragmentally elevational view of the first embodiment illustrating the features of a web applicator system;

FIG. 2A is a perspective view of a second embodiment of a contour vacuum applicator roll as viewed from the upper right side;

FIG. 2B-2F is a diagrammatic fragmentally elevational view of the second embodiment illustrating the features of a web applicator system;

FIG. 3A is a perspective view of a third embodiment of a contour vacuum applicator roll as viewed from the upper right side;

FIG. 3B-3F is a diagrammatic fragmentally elevational view of the third embodiment illustrating the features of a web applicator system;

FIG. 4A is a perspective view of a fourth embodiment of a contour vacuum applicator roll as viewed from the upper right side;

FIG. 4B-4F is a diagrammatic fragmentally elevational view of the fourth embodiment illustrating the features of a web applicator system.

FIG. 5 is a perspective view of the top portion of a first embodiment of a container;

FIG. 6 is a cross-sectional view taken substantially along the plane indicated by line 2-2 of FIG. 5;

FIG. 7 is a perspective view, with portions partially broken away, of the handle construction of the package of FIG. 5;

FIG. 8 is a cross-sectional view taken substantially along the plane indicated by line 4-4 of FIG. 5;

FIG. 9 is a perspective view of the top portion of a second embodiment of a container:

FIG. 10 is a cross-sectional view taken substantially along the plane indicated by line 3-3 of FIG. 9;

FIG. 11 is a perspective view. with portions partially broken away, of the handle construction of the package of FIG. 9;

FIG. 12 is a cross-sectional view taken substantially along the plane indicated by line 1-1 of FIG. 9;

FIG. 13 is a perspective view of the top portion of a third embodiment;

FIG. 14 is a cross-sectional view taken substantially along the plane indicated by line 5-5 of FIG. 13;

FIG. 15 is a cross-sectional view taken substantially along the plane indicated by line 6-6 of FIG. 13;

FIG. 16 is a perspective view of the top portion of a fourth embodiment of a container;

FIG. 17 is a top view taken substantially along the plane indicated by line A-A of FIG. 16;

FIG. 18 is a bottom view taken substantially along the plane indicated by line B-B of FIG. 16;

FIG. 19 is a perspective view of the top portion of a fifth embodiment of a container;

FIG. 20 is a top view taken substantially along the plane indicated by A-A of FIG. 19;

FIG. 21 is a perspective view of the top portion of a sixth embodiment of a container;

FIG. 22 is a cross-sectional view taken substantially along the plane indicated by line C-C of FIG. 21; and

FIG. 23 is a perspective view of the top portion of a seventh embodiment of a container.

### DETAILED DESCRIPTION

Disclosed herein is a system for forming a contoured material and applying it to a substrate. The presently disclosed methods and systems are useful with any type of material, and with any type of substrate. In one particular example, a tape with a coating of adhesive is applied to a substrate such as, for example, a paper product. The material may include, but is not limited to, various ribbon materials, various web materials, and various widths and lengths of material. The materials may include films, non-woven materials, paper materials, composite or laminated tapes, tear tapes or reinforcement tapes such as Sesame® and Enforcer® tapes available from Adalis, and tapes with adhesives. Particularly preferred are flexible materials that can form a handle and that include an adhesive such as a hot melt adhesive, a pressure sensitive adhesive, a remoistenable adhesive, a heat activated adhesive, a hot melt pressure sensitive adhesive, a hot melt remoistenable adhesive, a water dispersible hot melt adhesive, a biodegradable hot melt adhesive or a repulpable hot melt adhesive. Examples of these adhesives are any typical hot melt adhesive such as an ethylene-vinyl acetate copolymer (EVA-based) hot melt adhesive; EMA-based hot melt adhesive (ethylene methylacrylate); EnBA-based hot melt adhesive (ethylene n-butyl acrylate); hot melt adhesive based on polyamides; hot melt remoistenable adhesive based on polyamides and copolyesters; hot melt adhesives based on polyethylene and polypropylene homopolymers, copolymers and interpolymers, rubbery block copolymer hot melt adhesives; or RF (radio frequency) activatable adhesives. The material, for example, may generally be an adhesive tape comprising a backing of between 2 mils (0.05 mm) to about 7 mils (0.18 mm) in thickness comprised of a polymeric web selected from the group comprising polyester, polypropylene, polyethylene, and mixtures thereof.

The substrate may include films, non-woven webs, paper products, paper board, carton blanks, box board, corrugated board, and other sheet materials and web materials, all of various widths and lengths.

The present disclosure relates to methods and an applicator system for continuously contouring a cut length of material, and then continuously applying the contoured length of material at a predetermined position on a substrate or series of substrates. The contoured lengths of material are applied such that they are in registry with a predetermined location on the substrate. In certain embodiments, the system may include a material feed section which advances material from a supply, and places the material on a contour application vacuum roll. The contoured applicator vacuum roll shapes the material and advances the shaped material for application to a substrate.

In certain embodiments, the system 10 may include a feed section, generally designated 15, which advances material 11 from a supply (not shown), and places a cut length on a contoured application vacuum roll 25 in a desired length. This contoured applicator vacuum roll 25 shapes the material and advances the shaped cut lengths of material 11 to a substrate 12. In one embodiment, the web applicator section 15 comprises a contoured vacuum applicator roll 25, with the non-adhesive side of the tape 11 directed toward the surface of the contour applicator roll 25.

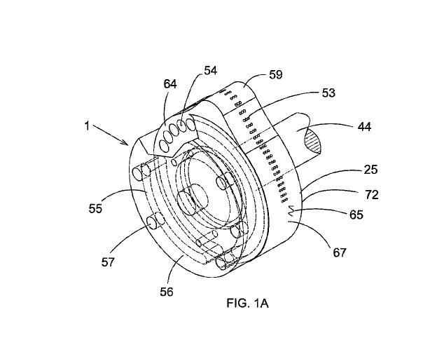

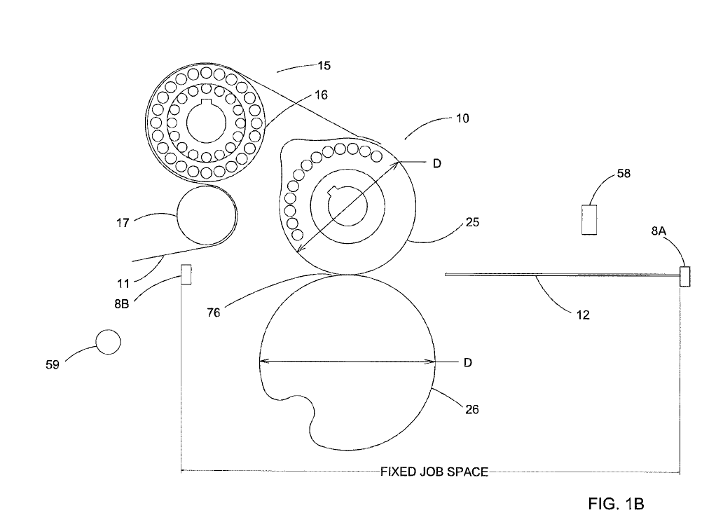

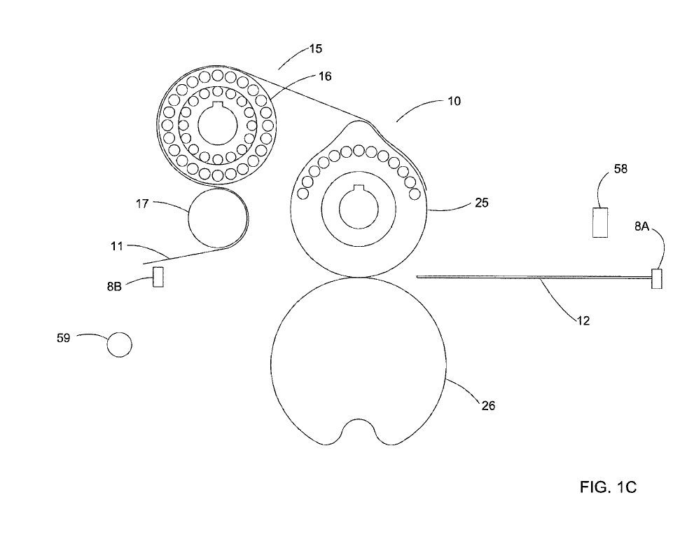

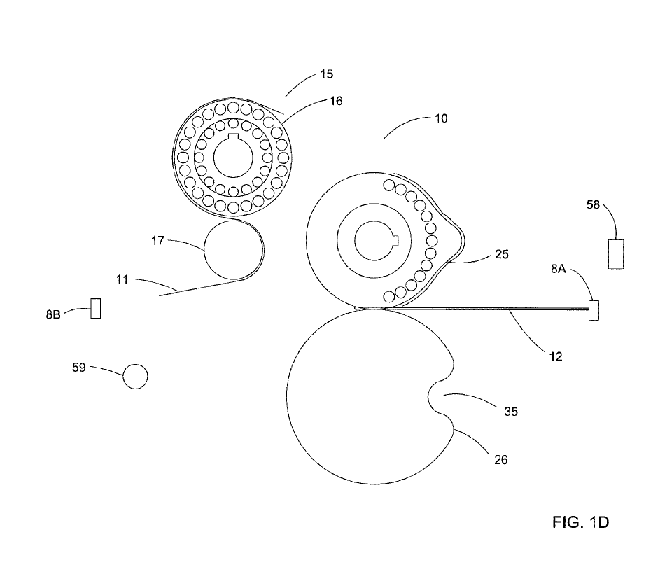

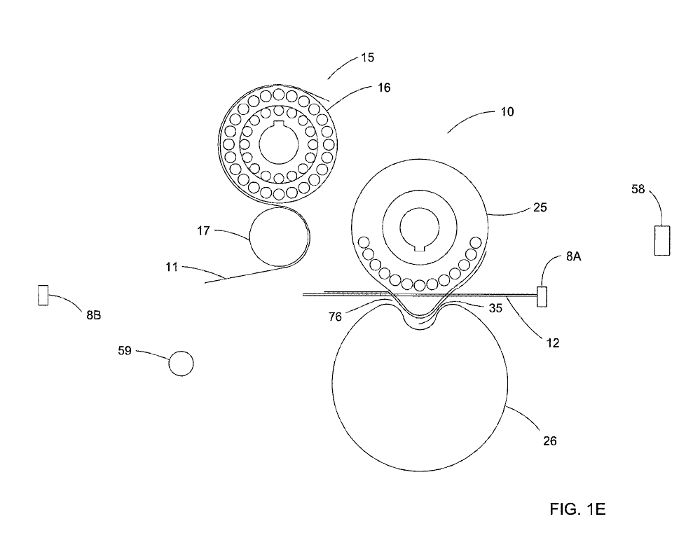

In a first embodiment shown in FIG. 1A, the contoured vacuum applicator roll 25 comprises a hub 67 mounted on a shaft 44. The hub 67 includes a first end wall 72 facing the shaft 44, and an opposing second end wall 64. The hub 67 is formed of metal or a composite of material, and may be coated with material having a coefficient of friction sufficient to aid in advancing the material 11. The hub 67 defines a peripheral surface 65 that is generally circular. The peripheral surface 65 defines a contoured portion 59 that has a convex protuberance shape. In certain embodiments, the convex protuberance includes a rounded apex and a spaced apart base. In certain embodiments, the contoured portion 59 consists of a single convex element. The non-adhesive surface of the material 11 may contact about 30 degrees to about 300 degrees of the surface 65 of the roll 25 centered on the contoured portion 59. The roll 25 includes a series of axially extended holes 54 formed in second end wall 64 of the hub. The holes 54 are positioned near the periphery of the roll 25 and are spaced circumferentially to communicate with axial rows of holes 53 defined in the surface 65 of the roll 25, and extending radially into the hub 67 from the peripheral surface 65. Mounted against the second end wall 64 of the hub 67 is a manifold 56. The manifold 56 includes grooved arcuate slot 55 that may extend about 90 to 325 degrees about its end wall adjacent axially to the end wall 64 of hub 67. The manifold 56 is supported in a fixed position by a bracket, and the slot 55 is positioned adjacent the path of the axially extended holes 54 on the hub 67. As the hub 67 of the contour roll 25 rotates, the holes 54 serially come into communication with the slot 55 and air is exhausted from the holes 54 and from the holes 53 creating a force against one side of the material 11 that is less than atmospheric (e.g., a vacuum), and thus the less-than atmospheric pressure holds the material 11 against the foraminous surface 65 of the roll 25 in the area of the slots 55 as it rotates the holes 54 along the slot 55. As the contoured vacuum roll 25 rotates, the holes 54 become aligned or substantially aligned with the slot 55 and the holes 53 draw the web material 11 against the surface 65 of the vacuum roll 25. The material 11 conforms to the shape of the contoured portion 59 when drawn against the surface 65 of the contoured roll 25. This moves the material 11 along with the rotation of the vacuum roll 25. During the continued rotation, the holes 54 are covered by the adjacent end wall of the manifold 56. The pressure holding the web material on the surface of the roll 25 over the holes 53 is such that the roll 25 moves the web material 11 at the same speed as the roll 25, not allowing slippage of web material 11 on the roll 25.

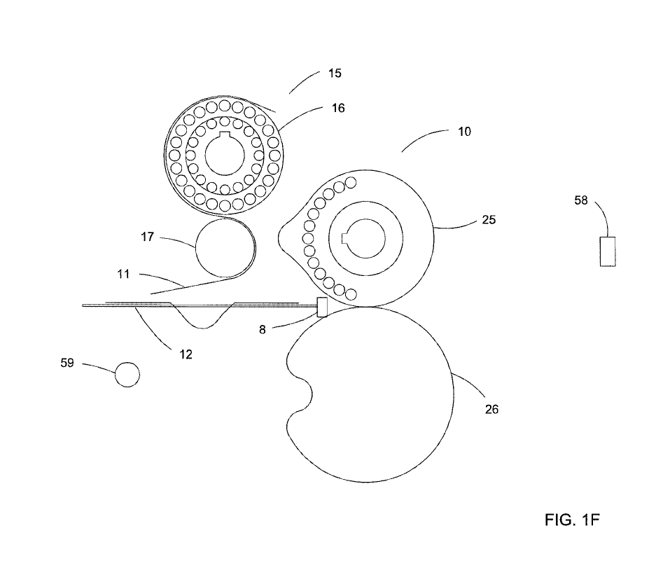

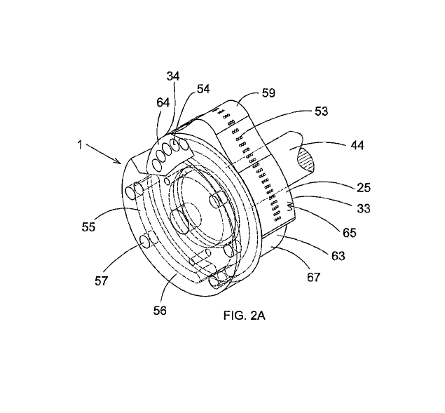

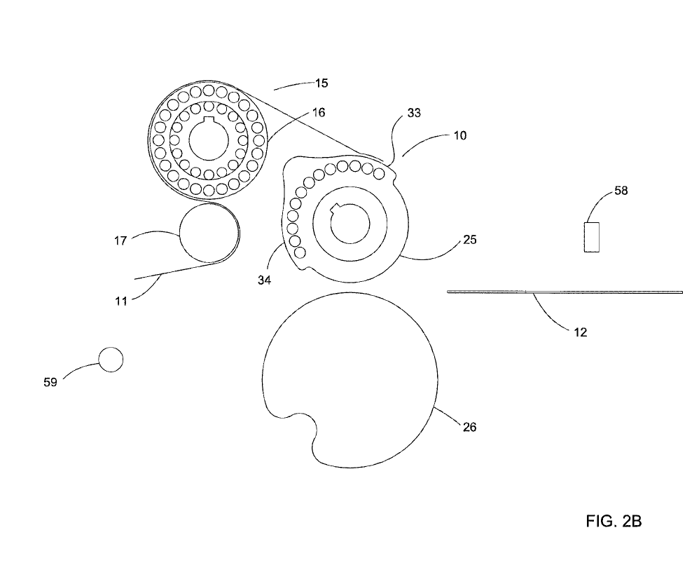

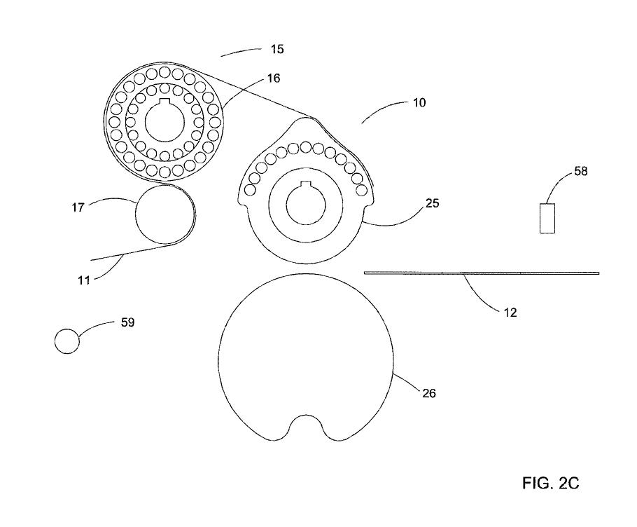

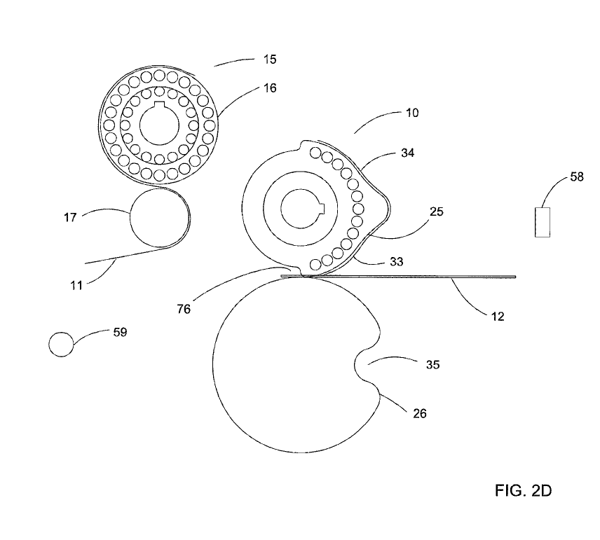

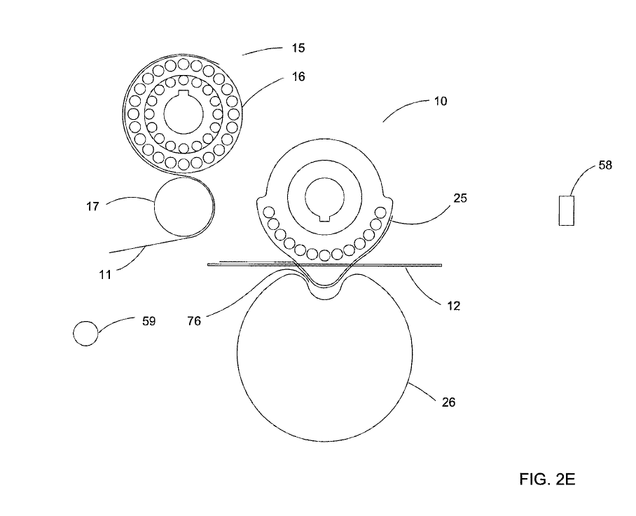

A second embodiment of a contoured vacuum roll 25 is shown in FIG. 2A. The periphery of vacuum roll 25 of FIG. 2A also includes a recessed portion 63 in addition to a contoured portion 59. The recessed portion 63 extends circumferentially around a section of the periphery of the vacuum roll that is opposing to the contoured portion 59. A first shoulder 33 is contiguous between a first end of the contoured portion 59 and a first end of the recessed portion 63, and a second shoulder 34 is contiguous between a second end of the contoured portion 59 and a second end of the recessed portion 63.

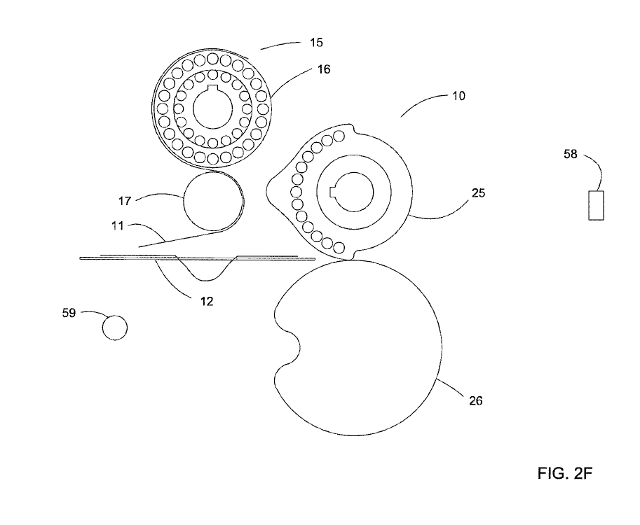

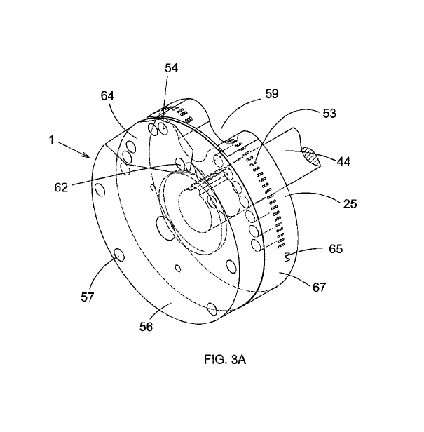

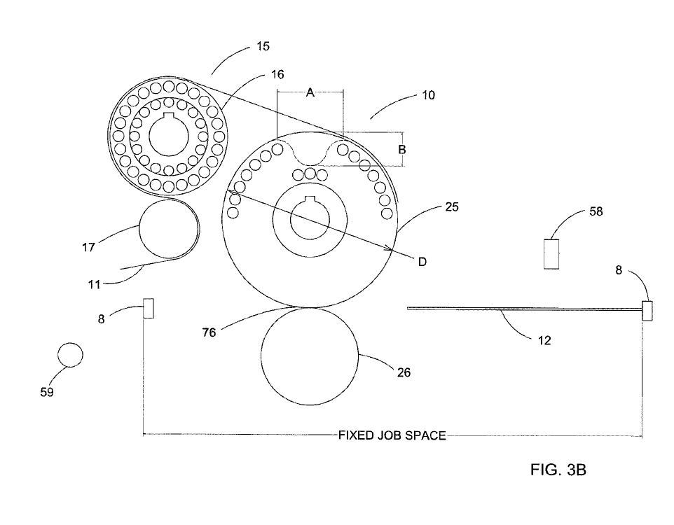

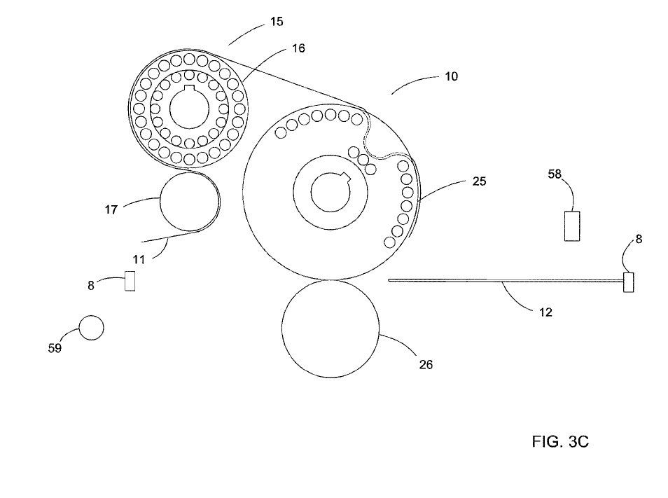

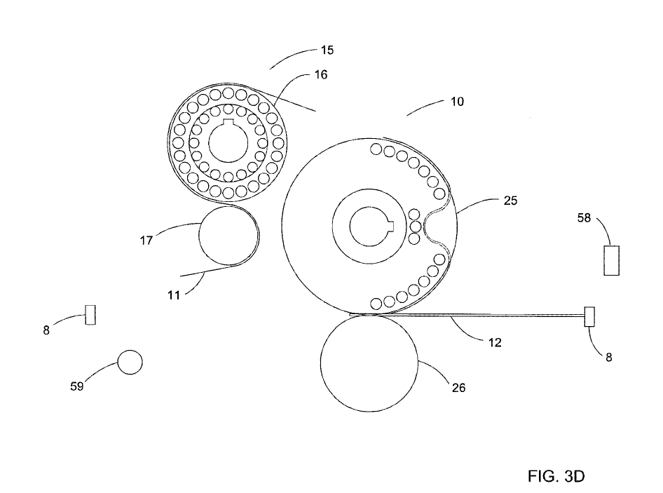

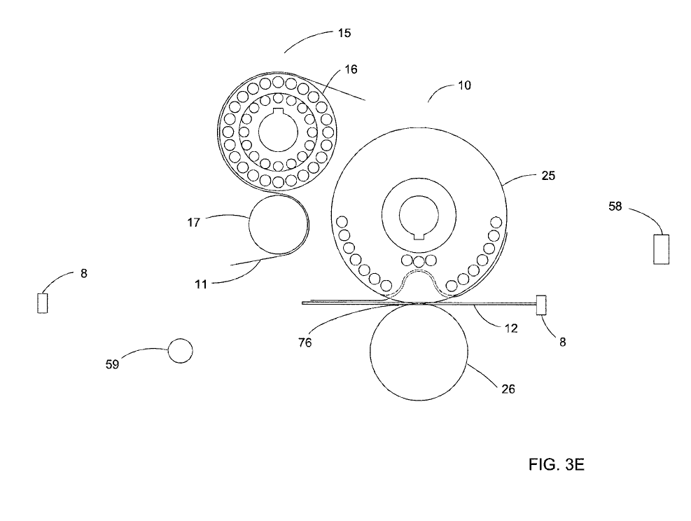

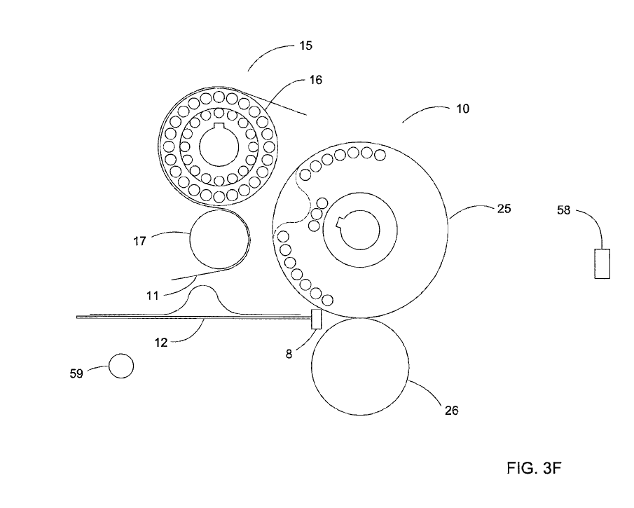

A third embodiment of a contoured vacuum roll 25 is shown in FIG. 3A. The peripheral surface 65 defines a contoured portion 59 that has a concave groove shape. In certain embodiments, the concave groove includes a rounded inverted apex and a spaced apart opening. In certain embodiments, the contoured portion 59 consists of a single concave element.

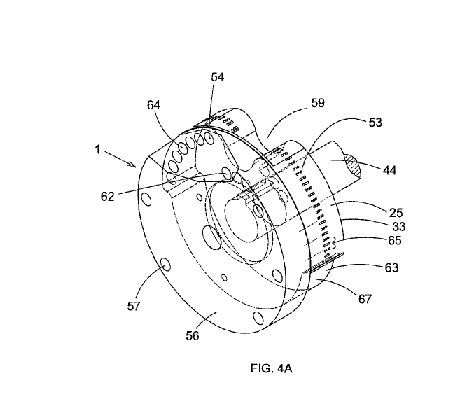

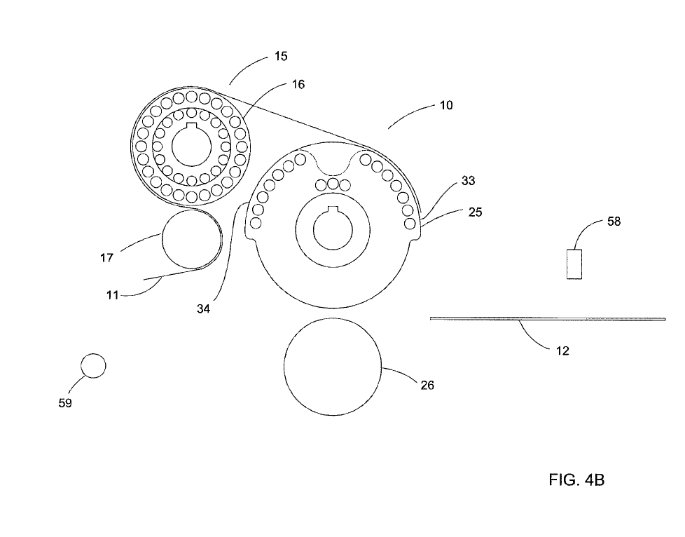

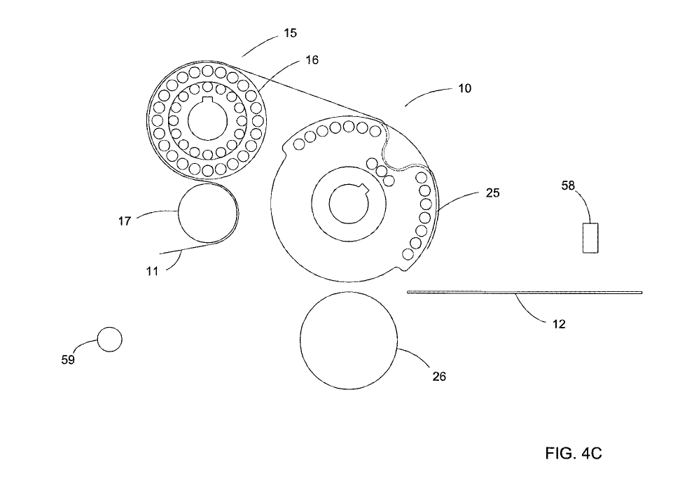

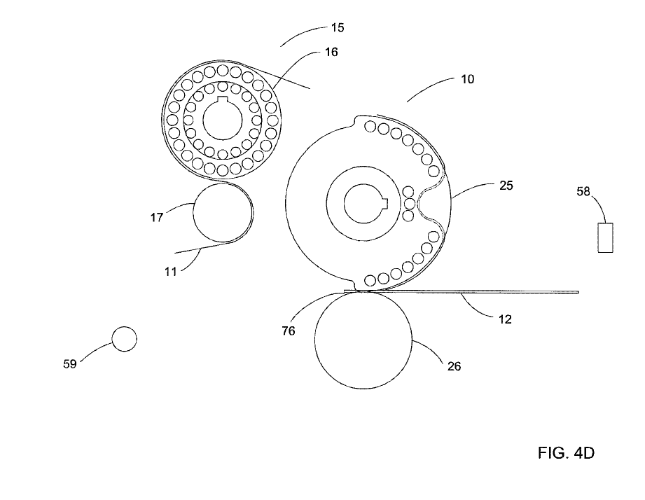

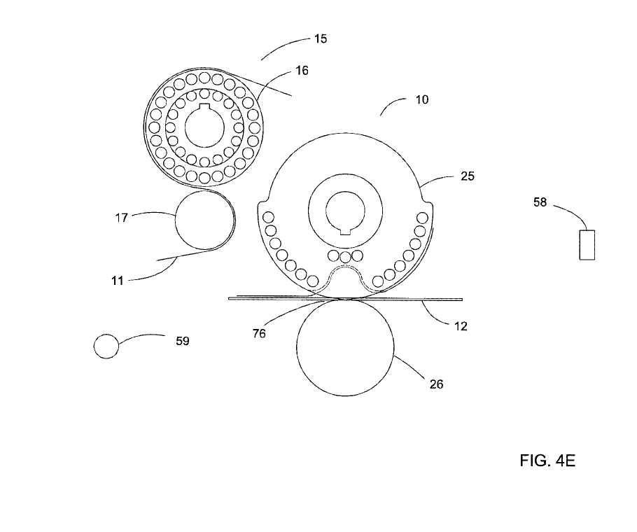

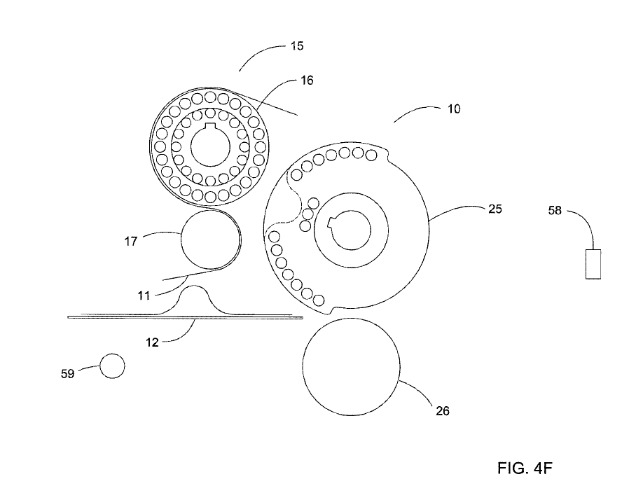

A fourth embodiment of a contoured vacuum roll 25 is shown in FIG. 4A. The periphery of vacuum roll 25 of FIG. 4A also includes a recessed portion 63 in addition to a contoured portion 59. The recessed portion 63 extends circumferentially around a section of the periphery of the vacuum roll that is opposing to the contoured portion 59. A first shoulder 33 is contiguous between a first end of the contoured portion 59 and a first end of the recessed portion 63, and a second shoulder 34 is contiguous between a second end of the contoured portion 59 and a second end of the recessed portion 63.

In the embodiment of FIG. 1A, the contoured vacuum roll 25 has a convex contoured portion 59 to allow for material application with a timed feed as shown on FIGS. 1B-1F. The contoured vacuum roll 25 holds the leading edge of each cut length of web material on the applicator roll 25 until it can be transferred onto the substrate 12. As the applicator roll 25 rotates, the leading edge of the material 11 advances past the end of the vacuum created section (defined by the area occupied by holes 53 when holes are engaged with arcuate groove 55 via holes 54). The leading edge of the material 11 is now no longer under the control of the vacuum applicator roll 25. Gravity and/or an air jet 57 cause the leading edge of the material 11 to leave the applicator roll 25 and to fall against substrate 12. As the vacuum roll 25 rotates, it continues to pick up more of the length of the material 11.

FIGS. 1B-1F, 2B-2F, 3B-3F, and 4B-4F depict applicator systems that include the first, second, third or fourth embodiments of the roll 25, respectively. Each set of FIGS. 1B-1F, 2B-2F, 3B-3F, and 4B-4F show the progression of a substrate 12 through the system 10. The applicator systems include an element that forms a nip 76 with the vacuum roll 25. In the depicted embodiments the element is a back roll 26, but the element could alternatively be a back belt or similar structures. The nip 76 is the region in which the cut length of material 11 is transferred from the vacuum roll 25 to the substrate 12.

In the systems of FIGS. 1B-IF and 2B-2F the convex contoured portion 59 of the roll 25 meshes with a concave notch 35 formed in the periphery of back roll 26. Meshing can be accomplished through mechanical, electromechanical, or electrical coupling the vacuum roll 25 with the back roll 26. In this embodiment, the shaft 44 is driven by a motor, such as a servomotor. Timing of the meshing of the vacuum roll 25 and the back roll 26 may be done through other power transmission and synchronization means known in the art including electronic coupling rather than mechanical coupling.

The first and third embodiments depicted in FIGS. 1A-1F and FIGS. 3A-3F respectively depict timed feed embodiments. The contoured vacuum roll 25 contoured portion 59 is synchronized with the back roll 26, upstream lug 8A and downstream lug 8B. In a timed feed application there is a fixed distance between lugs 8A and 8B on the substrate feed conveyor. The lug 8A contacts the leading edge of the substrate 12, thus indicating the presence and position of substrate 12. The fixed distance between two adjacent lugs defines the job space that the substrate falls within. The job-space is equal in length to the circumference πD of the vacuum roll 25 and back roll 26 in the embodiment shown in FIGS. 1A-F. Synchronization of the vacuum roll 25 to the back roll 26 and the lugs 8A and 8B cart be accomplished through electro-mechanical, electrical, or mechanical coupling known in the art.

The second and fourth embodiments depicted in FIGS. 2A-2F and 4A-4F, respectively, depict non-timed feed (random feed) embodiments. In a non-timed or random feed application there is not a fixed distance or job-space between the leading edge of one substrate to the leading edge of the adjacent substrate—i.e. no tugs 8 define a fixed job space. As described above, the contoured cut length of web material 11 is applied to a substrate 12. The substrate may be transported via a conveyor feed. The substrate conveyor feed section includes rollers and or belts, as known in the art, to move the substrate toward the nip area. The substrate 12 position and speed on the feed conveyor is determined by collaboration of sensor 58 and a line speed encoder 59. For non-timed feed the material placement upon the substrate is controlled by collaboration between a motor (not shown) and motor controller (nor shown) coupled to the shaft 44 of the vacuum roll 25 and the conveyor feed. The collaboration between these elements is synchronized through an Integrated Control System (ICS) such as Allen Bradley's Control Logix integrated control system. The ICS receives line speed information from the line speed encoder 59, the substrate sensor 58 both positioned along the substrate feed path and driven thereby. The peripheral speed of the vacuum roll 25 is matched to the line speed of the substrate 12 to properly position the web on the substrate just prior to the peripheral surface 65 of roll 25 coming in contact with the substrate 12 by the motor controller.

In the non-timed embodiments of FIGS. 2 and 4, recessed portion 63 does not contact the substrate 12 as the vacuum roll 25 rotates (see FIGS. 2B, 2C, 4B and 4C). As the end of the recessed portion 63 rotates past the nip area 76, first shoulder 33 comes into contact with the substrate 12 (see FIGS. 2D and 4D). As vacuum roll 25 continues to rotate, contoured portion 59 meshes with concave notch 35 formed in the back roll 26 (see FIG. 2E) or the contoured portion 59 passes over substrate 12. (see. FIG. 4E). The second shoulder 34 then contacts substrate 12. As the first shoulder 33, contoured portion 59, and second shoulder 34 successively pass the substrate surface, and simultaneously form a nip with the back roll 26, the vacuum roll 25, back roll 26, and the substrate 12 run at the same linear speed. However, when the first shoulder 33, contoured portion 59. or second shoulder 34 are not in contact with substrate 12 the substrate conveyor speed and the peripheral speed of vacuum roll 25 are not required to be equal. For example, the vacuum roll 25 could idle or run at a slower speed relative to the substrate conveyor speed, when the first shoulder 33, contoured portion 59, or second shoulder 34 are not in contact with substrate 12. This allows for the continuous production of non-equidistant substrates.

In the second embodiment shown in FIGS. 2A-2F, the contoured vacuum roll 25 section includes a convex contoured portion 59 and a recessed portion 63 to allow for material application without a timed feed.

In the third embodiment shown in FIGS. 3A-3F, the contoured vacuum roll 25 has a concave contoured portion 59 to allow for material application with a timed feed as described above in connection with FIGS. 1B-1F.

In the fourth embodiment shown in FIGS. 4A-4F, the contoured vacuum roll 25 has a concave contoured portion 59 and a recessed portion 63 to allow for material application without a timed feed as described above in connection with FIGS. 2B-2F.

The system 10 may include a feed section. 15 that includes a web material feed roll 16 and an idler pulley 17 for advancing the material from a feed material supply. The system 10 may also include a material preparation section for treating the material for application to the substrate 12. The preparation section may include a heater for applying heat to the material as it is on the vacuum roll 25. The cut material section is transferred to the substrate from the surface of the roll 25, as the substrate 12 and material length pass between the nip 76 formed between the vacuum roll 25 and the back roll 26. The preparation section may include a coating system to coat an adhesive to the material prior to introduction of the material onto roll 25. Alternatively, the system may include an adhesive coating system to coat an adhesive as it is on the material on the roll 25. The feed material could be pre-treated with an adhesive prior to use in system 10. The material 11 may be cut (e.g., with a knife roll) at any point prior to placement of the material 11 onto the substrate 12.

As described above, the contoured cut length of material 11 is applied to a substrate 12. The substrate may be transported via a conveyor feed. The substrate conveyor feed section includes rollers and or belts, as known in the art, to move the substrate toward the nip area, and cooperating sensor 58 and a line speed encoder 59 controls for placing the cut length of material precisely on the substrate 12. The material placement upon the substrate 12 may be controlled by an integrated control system (ICS) and motor. The ICS and motor controller receive line speed information from the line speed encoder 59 in collaboration with the sensor 58 both positioned along the substrate feed path and driven thereby. The peripheral speed of the vacuum applicator roll 25 is matched to the line speed of the substrate by the motor controller. When beginning a production run of cartons requiring a material length less than that of carton length, the machine operator first puts the length of the material information and material placement into the ICS. Any one of a multitude of material lengths cart be cut and placed on the substrate. A specific material length and placement is dictated by a particular carton production job order. A machine operator simply puts information into the ICS prior to the start of the material application production run. Any one of a multitude of material lengths can be cut and placed in a prescribed location on the carton blank as dictated by a particular carton production job order without having to stop the production line.

The presently disclosed application system is very versatile and can be adapted to applying any discrete contour piece of material of any length, at any position on a substrate of any shape or size. The length of the material can also be varied at will.

The substrate used in the presently disclosed methods and systems may be a carton blank or continuous board. The length of contoured material applied to a carton blank can extend the full length of the carton blank or can be applied only to a portion of the carton length and at a pitch ratio related to the length of the carton blank or web and the position of the length of material to the carton. The present applicator section 10 is described for use with the contoured vacuum roll 25 which contours and places the material onto the substrate 12. The contoured material placed on the substrate may serve as a carry handle, for example, on a finished carton. In one embodiment, to create a carry handle with the roll 25 depicted in FIGS. 3 and 4 the depth of the concave portion is approximately between 1 to 2 inches with a width of approximately 3 to 5 inches. In other embodiments, the dimensions may be different. Likewise, to create a carry handle with the roll 25 depicted in FIGS. 1 and 2 the height of the convex section is approximately between 1 and 2 inches with a width of approximately 3 to 5 inches. In other embodiments, the dimensions may be different. More generally, the proportion between the depth or height of the contoured portion to the base width of the contoured portion ranges from 1:5 to 2:3, including 2:5 and 1:3. The material, for example, may generally be an adhesive tape comprising a backing of between 2 mils (0.05 mm) to about 7 mils (0.18 mm) in thickness comprised of a polymeric web selected from the group comprising polyester, polypropylene, polyethylene, and mixtures thereof.

In certain embodiments, an opening such as an elongated or rectilinear opening is present in the substrate. The contoured portion 59 of the material 11 may be inserted into the substrate opening in the “convex” embodiments shown in FIGS. 1A and 2A. The contoured material may be applied over the substrate opening in the “concave” embodiments shown in FIGS. 3A and 4A. In the embodiments of FIGS. 3A and 4A the contoured portion 59 may be displaced through the substrate opening after application of the cut length of material to the substrate 12 (e.g., by displacement element downstream from the vacuum roll 25 or by hand). In these embodiments, the contoured material forms a handle comprising a flexible strip forming a collapsible loop having a continuous curvature along the full length of the loop that extends through the length of the opening in the substrate, wherein first and second portions of the flexible strip are adhesively affixed to the substrate as described below in more detail.

For example, also described herein are embodiments of a handle for an article, such as paper board or corrugated paper board containers that can be made by the systems and methods disclosed herein. The handle includes a flexible strip forming a loop that is affixed to an interior surface of a panel or flap of the corrugated or paperboard package. The strip extends through a complementary opening on the panel or flap and can extend vertically because of the formed loop to form a hand hold. The complementary opening may be covered by a panel larger than the complementary opening, wherein the panel is affixed to the interior surface of the panel or flap overlapping the strip affixed to the interior surface of the panel. Generally, the handle may be applied to a paperboard substrate or corrugated paperboard substrate during manufacturing of the substrate (e.g., a container blank), The handle disclosed herein is not a pre-formed handle unit (i.e., a two-part unit that includes a handle and a carrying element).

In certain embodiment, the substrate may be a corrugated paper board. The corrugated board substrate includes an exterior liner and a corrugated member. In some implementations, the corrugated member consists of a series of parallel flutes. However, in other implementations, the corrugated member can include other configurations, such as a waffle-type pattern or honeycomb. The corrugated paper board may be a single wall structure (i.e., includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand-carry carton that holds six, 12 or 24 bottles or cans of a beverage), meat and produce bulk bins, wet-packed containers, reusable containers, rubber and chemical bulk bins, heavy duty containers, bags, electronics and envelopes. A continuous corrugated board substrate can be manufactured by bonding the corrugated member to the exterior liner using an adhesive, and subjecting the exterior liner and corrugated member to heat.

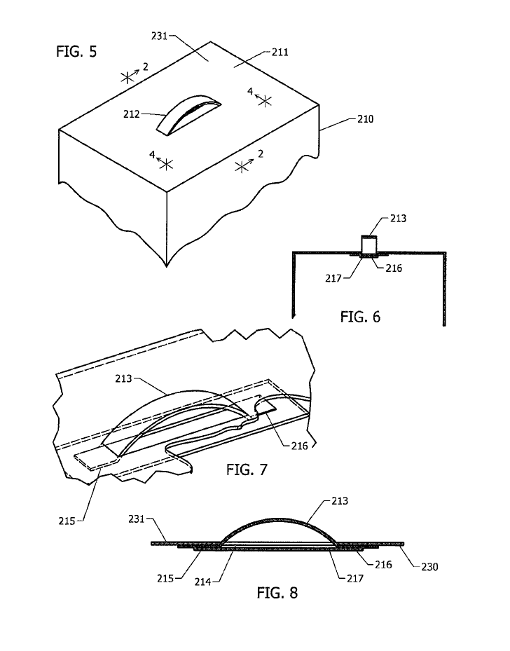

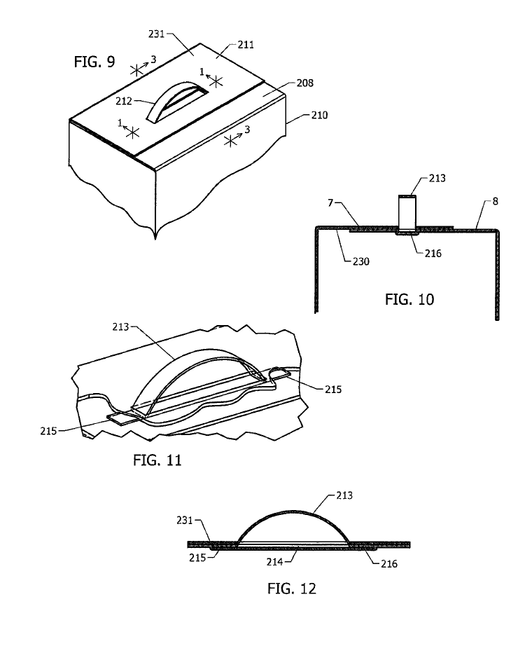

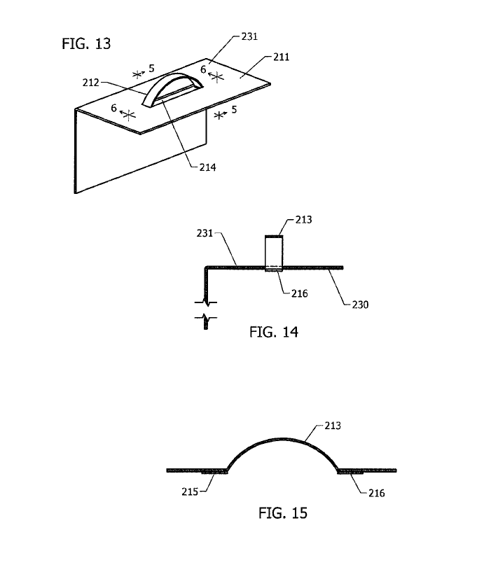

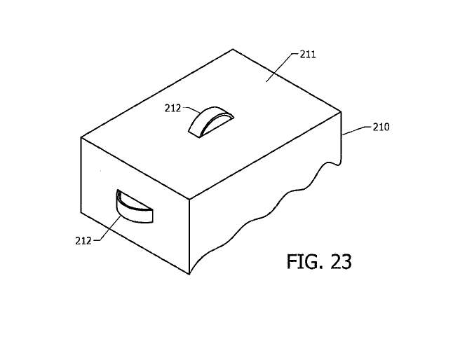

Referring to the FIGS. 5-23 in detail, wherein like numerals indicate like elements throughout the several views, a container 210 is provided with a top 211. In FIGS. 5-8, the longitudinal direction of the container is indicated by arrow 202, the axial direction of the container is indicated by arrow 204. In FIGS. 9-12, the longitudinal direction of the container is indicated by arrow 203; the axial direction of the container is indicated by arrow 201. In FIGS. 13-15, the longitudinal direction of the container is indicated by arrow 205, the axial direction of the container is indicated by arrow 206.

The container can be constructed of corrugated or folding carton paperboard. The top 211 has a centrally located, longitudinally-elongated opening 214. Adhesively affixed to an interior surface 230 of the top 211 is a handle 212. Container 210 also defines an exterior surface 231 opposing interior surface 230,. The handle structure 212 includes a flexible strip forming a loop 213 made from a material such as anon-woven fiber, film, tape, paperboard, or a combination thereof (e.g., a composite laminate) so that a length of the handle material greater than the longitudinal length of the opening 214 can be provided in the opening 214 which when extended upward will allow a hand there through to carry the container 210. End portions 215 and 216 of the strip forming the handle 212 are adhesively secured to the interior surface 230 of the top 211 adjacent opening 214, and the flexible loop 213 is then extended or deflected through the opening 214 into the top 211. The collapsible loop 213 has a continuous curvature that extends along the full length of the loop 213. For example, the collapsible loop 213 does not include a pleat or similar discontinuity along the length of the loop. As shown in FIG. 5, there is a single longitudinally-elongated opening 214 per handle 212 and the handle 122 extends the full length of the opening 214. In certain embodiments, the opening 214 has a rectilinear shape.

As mentioned above, the material for forming the flexible strip of the handle may be a non-woven fiber, film, tape, paperboard, or a combination thereof (e.g., a composite laminate). In one particular example, the material is a tape with a coating of adhesive applied to a substrate such as, for example, a paper product. The material may include, but is not limited to, various ribbon materials, various web materials, and various widths and lengths of material. The materials may include films, non-woven materials, paper materials, composite or laminated tapes, tear tapes or reinforcement tapes such as Sesame® and Enforcer® tapes available from Adalis, and tapes with adhesives. Particularly preferred are flexible materials that can form a handle and that include an adhesive such as a hot melt adhesive, a pressure sensitive adhesive, a remoistenable adhesive, a heat activated adhesive, a hot melt pressure sensitive adhesive, a hot melt remoistenable adhesive, a water dispersible hot melt adhesive, a biodegradable hot melt adhesive or a repulpable hot melt adhesive. Examples of these adhesives are any typical hot melt adhesive such as an ethylene-vinyl acetate copolymer (EVA-based) hot melt adhesive; EMA-based hot melt adhesive (ethylene methylacrylate); EnBA-based hot melt adhesive (ethylene n-butyl acrylate); hot inch adhesive based on polyamides; hot melt remoistenable adhesive based on polyamides and copolyesters; hot melt adhesives based on polyethylene and polypropylene homopolymers, copolymers and interpolymers, rubbery block copolymer hot melt adhesives; or RF (radio frequency) activatable adhesives. The material, for example, may generally be an adhesive tape comprising a backing of between 2 mils (0.05 mm) to about 7 mils (0.18 mm) in thickness comprised of a polymeric web selected from the group comprising polyester, polypropylene, polyethylene, and mixtures thereof.

In certain embodiments, in order to preclude contaminants from entering container 210 through opening 214 in the top 211, a panel 217 larger in area compared to opening 214 is adhesively secured to the interior surface of the top 211 bordering opening 214 and sandwiching the end portions 215 and 216 between the adhering surface of the panel 217 and the interior surface of the top 211. In certain embodiments the cover panel is complementary in shape to the opening in the top of the container. In use, the flexible loop 213 enables it to be extended and raised upward through complementary opening 14 where it can be grasped by the hand in order to carry the package. The panel 217 precludes dirt or other contamination from entering the interior of the carton 210.

In a second embodiment shown in FIGS. 9-12, a container 210 is provided with a top 211 including a pair of overlapping flaps 207 and 208 which are connected together for example via an adhesive. The container 210 can be constructed of corrugated or folding carton paperboard. Closure flap 207 has centrally located, longitudinally-elongated opening 214. Connected to an interior surface 230 of the closure flap 207 is a flexible handle 212. Container 210 also defines an exterior surface 231. The handle structure 212 includes a flexible strip forming a loop 213 made from a material such as a non-woven fiber, film, tape, paperboard, or a combination thereof (e.g., a composite laminate) so that a length of the handle material greater than the longitudinal length of the opening 214 can be provided in the opening 214 which when extended upward will allow a hand there through to carry the container 210. End portions 215 and 216 of the strip forming the handle 212 are adhesively secured to the interior surface 230 of upper closure flap 207 adjacent opening 214, and the flexible loop 213 is then extended through the opening 214 in top flap 207. Closure flap 207 is then secured to the closure flap 208 and the loop 213 of handle 212 extends through the opening 214 thereof. The collapsible loop 213 has a continuous curvature that extends along the full length of the loop 213. For example, the collapsible loop 213 does not include a pleat or similar discontinuity along the length of the loop. As shown in FIG. 9, there is a single longitudinally-elongated opening 214 per handle 212 and the handle 212 extends the full length of the opening 214. In certain embodiments, the opening 214 has a rectilinear shape.

In order to preclude contaminants from entering container 210 through complementary opening 214 in the top flap 207, the lower flap 208 which has no such complementary opening is adhesively secured to the rear or interior surface of lower flap 208. In use, the flexible loop 213 enables it to be extended and raised upward through complementary opening 214 where it can be grasped by the hand in order to carry the package, The lower flap 208 precludes dirt or other contamination from entering the interior of the container 210.

In a third embodiment shown in FIGS. 13-15, a substrate has a centrally located, elongated opening 214. Connected to a first surface 230 of the substrate is a handle 212. The handle structure 212 includes a flexible strip forming a loop 213 made from a material such as a non-woven fiber, film, tape, paperboard, or a combination thereof (e.g., a composite laminate) so that a length of the handle material greater than the longitudinal length of the opening 214 can be provided in the opening 214 which when extended upward will allow a hand there through to carry the container 210. End portions 215 and 216 of the strip forming a handle 212 are adhesively secured to the interior surface 230.

In use, the flexible strip 213 enables it to be extended and raised upward through complementary opening 214 where it can be grasped by the hand in order to carry the substrate. The substrate can be constructed of corrugated or folding carton paperboard.

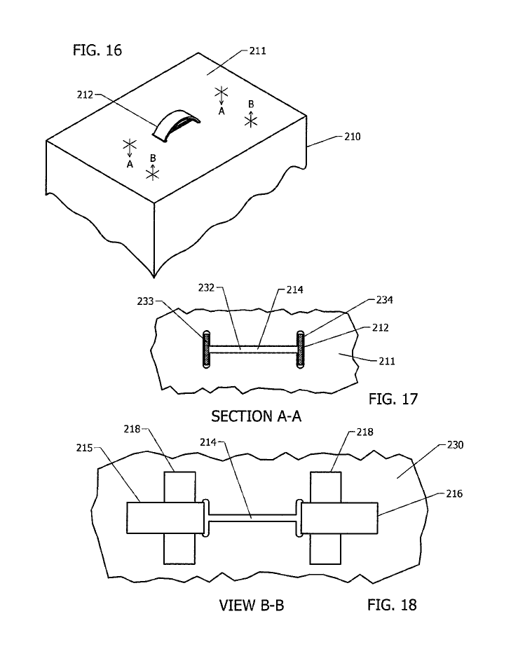

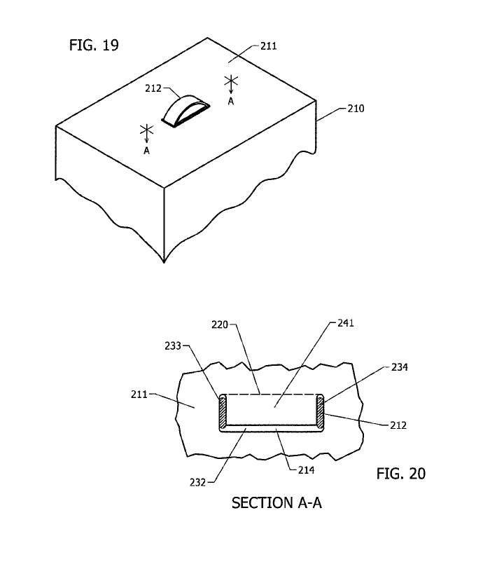

A fourth embodiment is shown in FIGS. 16-18, The top 21 of the container 210 is provided with a longitudinally-elongated opening 214 that includes a central longitudinally-elongated portion 232 extending between, and connecting, two opposing axially-extending portions 233 and 234, The handle 212 is received within the axially-extending portions 233 and 234, respectively. In the embodiment shown in FIG. 17 the central longitudinally-elongated portion 232 is located at a vertical mid-point of each of the two opposing axially-extending portions 233 and 234. In another embodiment shown in FIGS. 19 and 20, the central longitudinally-elongated portion 232 may be located at an end of each of the two opposing axially-extending portions 233 and 234. A score line 220 may be provided between the axially-extending portions 233 and 234 to provide a hingeable section 241 that is contiguous with opening 214. In the embodiment shown in FIG. 18, a reinforcing tape 218 is disposed between the interior surface 230 of container top 211 and the first and second end portions 215 and 216 of the handle 212. The first and second end portions 215 and 216 of the handle 212 may be adhesively affixed to the interior surface 230 and the reinforcing tape 218.

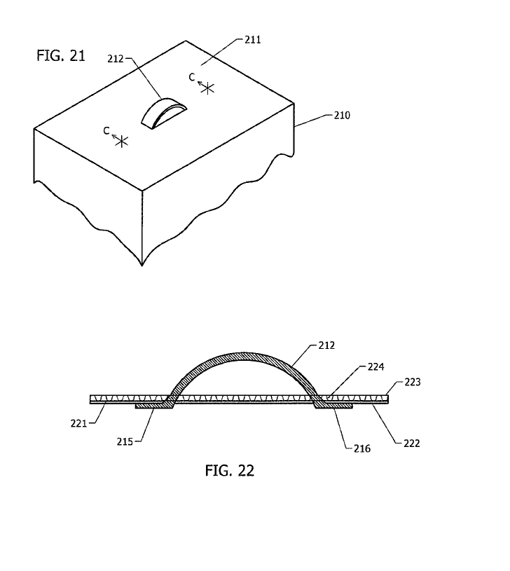

A further embodiment is shown in FIGS. 21 and 22. A reinforcement tape 221 is disposed between an interior liner 222, and corrugated flutes 224. An exterior liner 223 is disposed adjacent to the exterior surface of the corrugated flutes 224. End portions 215 and 216 of the handle 212. are adhesively affixed to the interior surface of the interior liner 222. The reinforcement tape 221 reinforces the container at the locations of the end portions 215 and 216.

In certain embodiments the flexible handle 212 can function as a strap for suspending on a hook, pulling, or restraining the container.

The material can be applied to the substrate at any substrate speeds. According to certain examples, the substrate speed may be about 200 to about 1200 or higher feet per minute, more particularly about 600 to 1000 feet per minute when a PSA or hot melt adhesive-containing web material is applied to carton blanks.

In view of the many possible embodiments to which the principles of the disclosed invention may be applied, it should be recognized that the illustrated embodiments are only preferred examples of the invention and should not be taken as limiting the scope of the invention.

What is claimed is:

1. A system comprising:
a vacuum roll configured to receive a material, wherein the vacuum roll defines a peripheral surface having a contoured portion; and
an element forming a nip with the vacuum roll so that the material from the vacuum roll can be applied to a substrate advancing through the nip.

2. The system of claim 1, wherein the contoured portion forms a convex shape.

3. The system of claim 2, wherein the vacuum roll peripheral surface further includes a recessed portion.

4. The system of claim 3, wherein the contoured portion opposes the recessed portion.

5. The system of claim 1, wherein the contoured portion forms a concave shape.

6. The system of claim 5, wherein the vacuum roll peripheral surface further includes a recessed portion.

7. The system of claim 2, wherein the element defines a peripheral surface, wherein the peripheral surface has a concave portion that conforms to the convex shape of the vacuum roll.

8. The system of claim 1, wherein the system further comprises an adhesive applying module configured to apply an adhesive to the material.

9. The system of claim 1, further comprising at least one sensor and at least one line encoder configured for sensing the substrate position.

10. The system of claim 9, further comprising a controller configured to receive a signal from the at least one sensor and the at least one line encoder and synchronize the position of the material from the vacuum roll to the substrate.

11. The system of claim 2, wherein the contoured portion forms only a single convex element.

12. The system of claim 5, wherein the contoured portion forms only a single concave element.

13. The system of claim 1, wherein the vacuum roll comprises:
a hub that defines the peripheral surface, and comprises a first wall, a second wall, axially extending first holes formed in the first wall, and second holes formed in the peripheral surface, wherein the first holes communicate with the second holes; and
a manifold coupled to the first wall of the hub, the manifold comprising an arcuate slot configured to serially communicate with the first holes of the hub.

14. A vacuum roll comprising:
a hub that defines a peripheral surface having a contoured portion, and comprises a first wall, a second wall, axially extending first holes formed in the first wall, and second holes formed in the peripheral surface, wherein the first holes communicate with the second holes; and
a manifold coupled to the first wall of the hub, the manifold comprising an arcuate slot configured to serially communicate with the first holes of the hub.

15. A method for applying a contoured material to a substrate, comprising:
advancing a material from a feed section to a vacuum roll, wherein the vacuum roll defines a peripheral surface having a contoured portion;
advancing the material along the peripheral surface of the vacuum roll so as to form a contour in the material;
advancing the contoured material along the peripheral surface of the vacuum roll to a nip between the vacuum roll and a back roll; and
applying the contoured material to a substrate advancing through the nip.

16. The method of claim 15, wherein the contoured portion forms a convex shape.

17. The method of claim 16, wherein the vacuum roll peripheral surface further includes a recessed portion.

18. The method of claim 17, wherein the contoured portion opposes the recessed portion.

19. The method of claim 15, wherein the contoured portion forms a concave shape.

20. The method of claim 19, wherein the vacuum roll peripheral surface further includes a recessed portion.

21. The method of claim 15, wherein the contoured material is inserted into an opening present in the substrate.

22. The method of claim 15, wherein the contoured material is applied over an opening present in the substrate.
